(19) United States
(12) Patent Application Publication
(10) Pub. No.: US 2014/0354430 A1
(43) Pub. Date: Dec. 4, 2014

(54) ENERGY HARVESTING, AMBIENT LIGHT FLUCTUATION SENSING INTRUSION DETECTOR

(71) Applicant: UTC Fire and Security Americas Corporation, Inc., Bradenton, FL (US)

(72) Inventors: Nicholas Charles Soldner, Southbury, CT (US); Penghe Geng, Vernon, CT (US); Vijaya Ramaraju Lakamraju, Longmeadow, MA (US); Suman Dwari, Manchester, CT (US); Joseph Zacchio, Wethersfield, CT (US)

(73) Assignee: UTC Fire and Security Americas Corporation, Inc., Bradenton, FL (US)

(21) Appl. No.: 14/293,180

(22) Filed: Jun. 2, 2014

Related U.S. Application Data
(60) Provisional application No. 61/830,378, filed on Jun. 3, 2013.

(51) Int. Cl. G08B 13/189

(52) U.S. Cl. CPC G08B 13/1895
USPC 340/555

(57) ABSTRACT

Embodiments are directed to detecting that an intrusion is occurring by detecting, by a first sensor, that the intrusion is occurring based on a variation of light exceeding a threshold, detecting, by a second sensor, that the intrusion is occurring, and generating an intrusion status signal that indicates the intrusion is occurring based on determining that the first and second sensors detect that the intrusion is occurring.

### CROSS-REFERENCE TO RELATED APPLICATIONS

This application claims the benefit of U.S. provisional patent application Ser. No. 61/830,378, filed Jun. 3, 2013, the entire contents of which are incorporated herein by reference.

### BACKGROUND

An intrusion detector typically includes a sensor designed to sense motion within a room or an opening of a door or window. Intrusion detectors often generate false positives (e.g., signal or indicate an intrusion when no actual intrusion is occurring). Intrusion detector sensors generally use one sensing modality to detect an intrusion event. Some recent models include multi-modal sensing, however false alarms are still of concern. Common examples of these modalities include passive infrared, vibration (shock), and movement (magnetic contact). Reliance on a single sensing modality imposes limits on the ability to discriminate between actual and false intrusion events. Furthermore, wireless intrusion detectors suffer from limited battery life, thereby imposing a ceiling on their operational lifetime before the battery needs to be replaced.

### BRIEF SUMMARY

An embodiment is directed to a method for detecting that an intrusion is occurring, comprising: detecting, by a first sensor, that the intrusion is occurring based on a variation of light exceeding a threshold, detecting, by a second sensor, that the intrusion is occurring, and generating an intrusion status signal that indicates the intrusion is occurring based on determining that the first and second sensors detect that the intrusion is occurring.

An embodiment is directed to a sensing unit, comprising: a first sensor configured to detect that an intrusion is occurring based on a variation of light exceeding a threshold, a second sensor configured to detect that the intrusion is occurring, and logic configured to generate an intrusion status signal that indicates the intrusion is occurring based on the first and second sensors detecting that the intrusion is occurring.

An embodiment is directed to a system comprising: a sensing unit comprising: a first sensor configured to detect that an intrusion is occurring based on a variation of light exceeding a threshold, a second sensor configured to detect that the intrusion is occurring, and logic configured to generate an intrusion status signal that indicates the intrusion is occurring based on the first and second sensors detecting that the intrusion is occurring, and a security panel comprising: a receiver configured to receive the intrusion status signal, and an interface configured to signal that an intrusion has been detected based on the received intrusion status signal.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating a system in accordance with one or more embodiments;

FIG. 2 illustrates a state diagram in accordance with one or more embodiments;

FIG. 3 illustrates a state diagram in accordance with one or more embodiments;

FIG. 4 illustrates a schematic block diagram of a circuit in accordance with one or more embodiments; and

FIG. 5 illustrates a schematic block diagram of a plurality of sensors in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for detecting whether an intrusion event occurs. In some embodiments, a photovoltaic (PV) sensor may be used to harvest energy. The harvested energy may be used to power another sensor, such as a power consuming sensor (e.g., PIR). In some embodiments, the PV sensor and the PIR sensor may be used to detect whether an intrusion occurs, thereby reducing the likelihood or probability that a false positive would be generated relative to the use of the PIR sensor alone. In some embodiments, the PIR sensor may generally be off or asleep and may be turned on or awaken when the PV sensor detects an intrusion. In this manner, power consumption of the PIR sensor may be reduced.

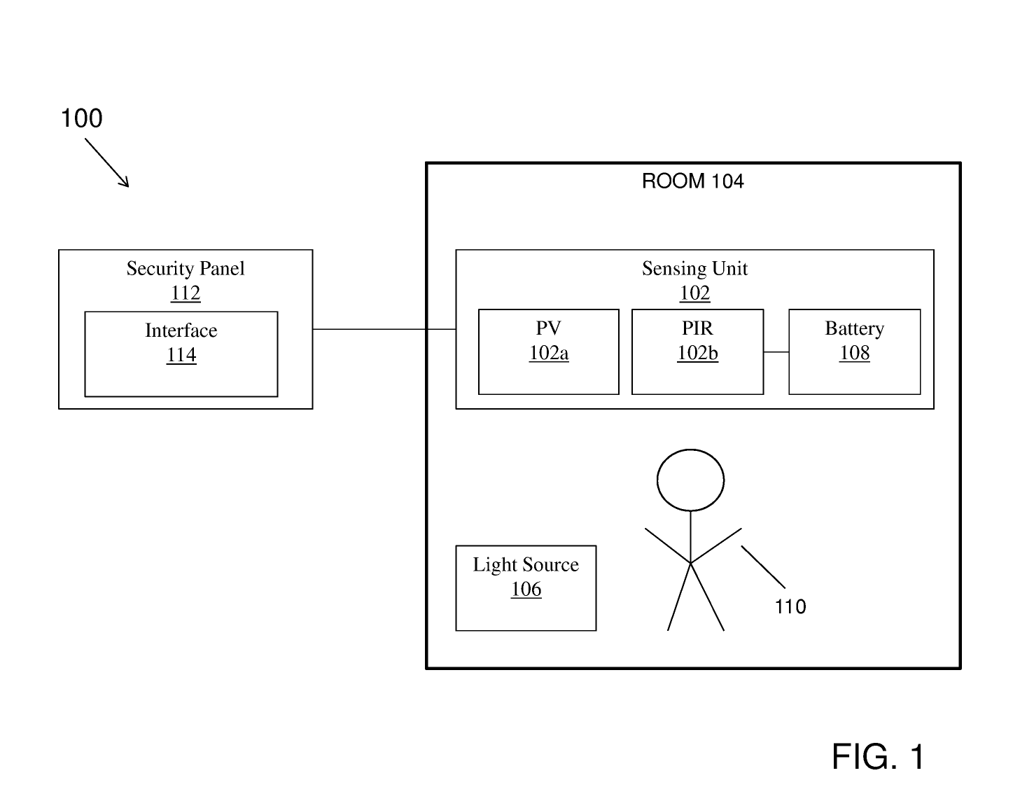

Referring to FIG. 1, an exemplary system 100 is shown. The system 100 is shown as including a sensing unit 102. The sensing unit 102 may be configured to detect whether an intrusion event occurs. The sensing unit 102 may be located in a room 104. In some embodiments, the sensing unit 102 may be placed on a wall, a door, a window, or at any other location.

The sensing unit 102 may include one or more sensors. For example, the sensing unit 102 is shown in FIG. 1 as including a PV sensor 102a and a PIR sensor 102b.

The PIR sensor 102b may include any type of sensor. For example, the PIR sensor 102b may include one or more of a passive infrared sensor, radar or radio frequency (RF) based sensor, a door/window sensor that may be configured to operate on the basis of a reed switch or magnetics, and an acoustic sensor that may be configured to operate on the basis of acoustic waves, such as acoustic waves that may be generated when the glass of a window is shattered.

The PV sensor 102a may be configured to harvest energy. Such harvested energy may at least partially originate from, or be derived from, one or more sources, such as a light source 106. For example, the light source 106 may include sunlight, indoor light, etc.

In some embodiments, the energy harvested by the PV sensor 102a may be used to supplement power provided to the PIR sensor 102b by a battery 108. In some embodiments, the energy harvested by the PV sensor 102a may be sufficient, such that the battery 108 might not be needed or included.

Shown in FIG. 1 is a person 110. Person 110 may be an intruder, such that the presence of the person 110 in the room 104 is intended to be detected by the sensing unit 102. The sensing unit 102 (e.g., the PV sensor 102a and/or the PIR sensor 102b) may detect the person 110 based on, e.g., reflected light, infrared “light”, etc.

When the sensing unit 102 detects the presence of the person 110 in the room 104, the sensing unit 102 may communicate such status to a security panel 112. The sensing unit 102 may communicate the status to the security panel 112 wirelessly. The security panel 112 may include an interface 114 that may signal whether an intrusion has been detected. Such signaling may take one or more forms in connection with the interface 114, such as a displayed message, an auditory alert, etc.

While the security panel 112 is shown as being remotely located from the room 104, in some embodiments the security panel 112 may be located in the room 104.

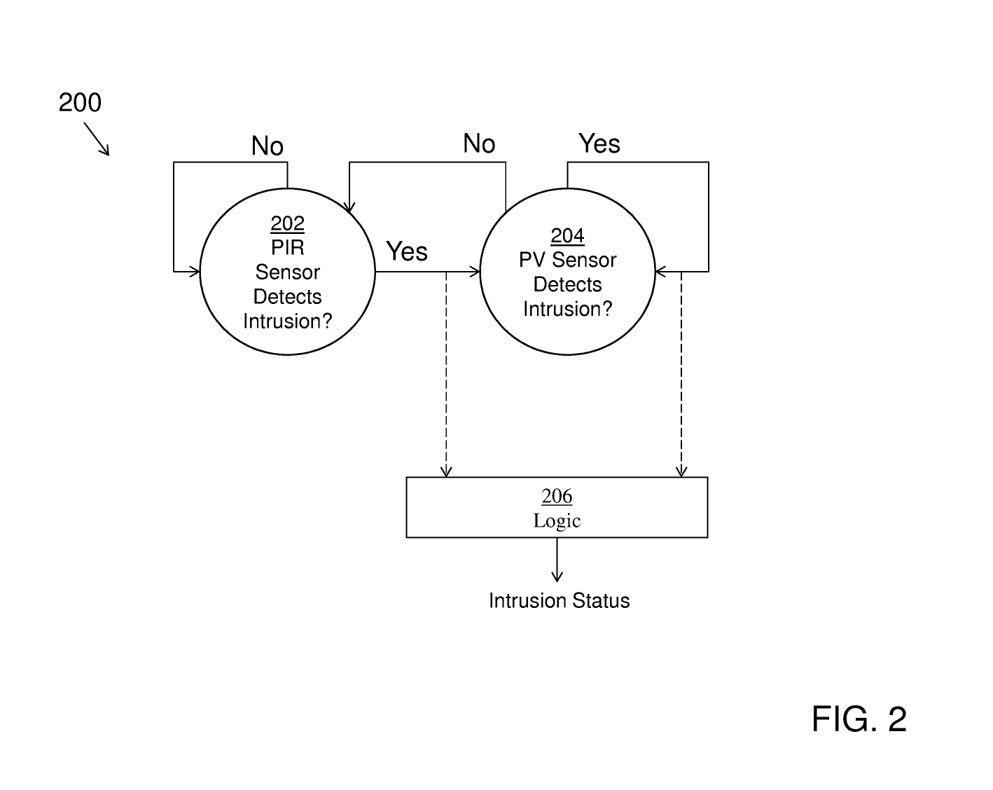

Turning now to FIG. 2, a state diagram 200 in accordance with one or more embodiments is shown. In some embodiments, the state diagram 200 may be implemented in the sensing unit 102 and/or the security panel 112. The state diagram 200 may be used to reduce the likelihood of triggering a false positive with respect to detection of an intrusion.

State 202 may correspond to an initial state. In state 202, the PIR sensor 102b may be on or enabled and may be configured to detect whether an intrusion is occurring. If the PIR sensor 102b does not detect an intrusion (e.g., the “No” path is taken out of state 202), flow may remain at state 202. Otherwise, if the PIR sensor 102b does detect an intrusion (e.g., the “Yes” path is taken out of state 202), flow may proceed from state 202 to state 204.

In state 204, the PV sensor 102a may be configured to detect whether an intrusion is occurring. If the PV sensor 102a detects an intrusion (e.g., the “Yes” path is taken out of state 204), flow may remain at state 204. Otherwise, if the PV sensor 102a does not detect an intrusion (e.g., the “No” path is taken out of state 204), flow may proceed from state 204 to state 202.

The results of the detection performed by the PIR sensor 102b and the PV sensor 102a in FIG. 2 may be combined or examined via logic 206 to generate an intrusion status output. For example, logic 206 may include or implement an “AND” function, such that the intrusion status may indicate or signify an intrusion only when both the PIR sensor 102b and the PV sensor 102a indicate that an intrusion is detected. In this manner, the likelihood of generating a false positive may be reduced relative to simply using the output of the PIR sensor 102b alone.

In some embodiments, the logic 206 may be implemented as one or more logic gates or via algorithms running on an existing intrusion sensor processor.

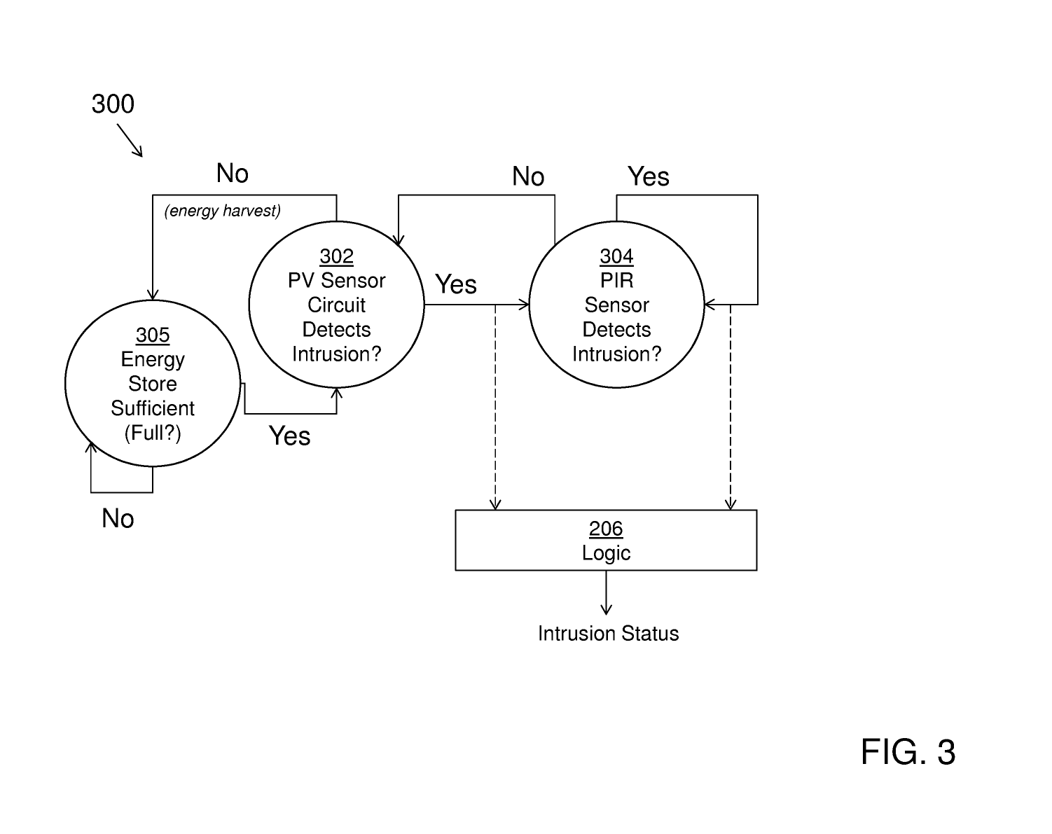

Turning now to FIG. 3, a state diagram 300 in accordance with one or more embodiments is shown. In some embodiments, the state diagram 300 may be implemented in the sensing unit 102 and/or the security panel 112. The state diagram 300 may be used to reduce power consumption, such as the power consumption of the PIR sensor 102b.

State 302 may correspond to an initial state. In state 302, the PIR sensor 102b may be off or disabled in order to reduce a power consumption of the PIR sensor 102b. In state 302, the PV sensor 102a may be configured to detect whether an intrusion is occurring. If the PV sensor 102a does not detect an intrusion (e.g., the “No” path is taken out of state 302), flow may remain at state 302 or flow may proceed to state 305. Otherwise, if the PV sensor 102a does detect an intrusion (e.g., the “Yes” path is taken out of state 302), flow may proceed from state 302 to state 304. As part of the flow from state 302 to state 304, the PIR sensor 102b may be turned on or enabled.

As part of the transition from state 302 to state 305, energy may be harvested. For example, energy may be harvested by a PV sensor (e.g., PV sensor 102a). In state 305, a determination may be made whether an energy storage associated with the PV sensor is sufficient, e.g., greater than a threshold. In some embodiments, the threshold may be set to correspond to a full energy storage. If the energy storage is sufficient (e.g., the “Yes” path is taken out of state 305), flow may proceed from state 305 to state 302. Otherwise, if the energy storage is insufficient (e.g., the “No” path is taken out of state 305), flow may remain at state 305.

In state 304, the PIR sensor 102b may be on or enabled. In state 304, the PIR sensor 102b may be configured to detect whether an intrusion is occurring. If the PIR sensor 102b detects an intrusion (e.g., the “Yes” path is taken out of state 304), flow may remain at state 304. Otherwise, if the PIR sensor 102b does not detect an intrusion (e.g., the “No” path is taken out of state 304), flow may proceed from state 304 to state 302. As part of the flow from state 304 to state 302, the PIR sensor 102b may be turned off or disabled in order to reduce a power consumption of the PIR sensor 102b.

The results of the detection performed by the PIR sensor 102b and the PV sensor 102a in FIG. 3 may be combined or examined via logic 206 in a manner similar to that described above.

Thus, relative to the state diagram 200, operation associated with the state diagram 300 may be used to reduce power consumption of the PIR sensor 102b by generally keeping the PIR sensor 102b off or disabled, and only powering the PIR sensor 102b when detection by the PIR sensor 102b is needed (e.g., when the PV sensor 102a detects an intrusion).

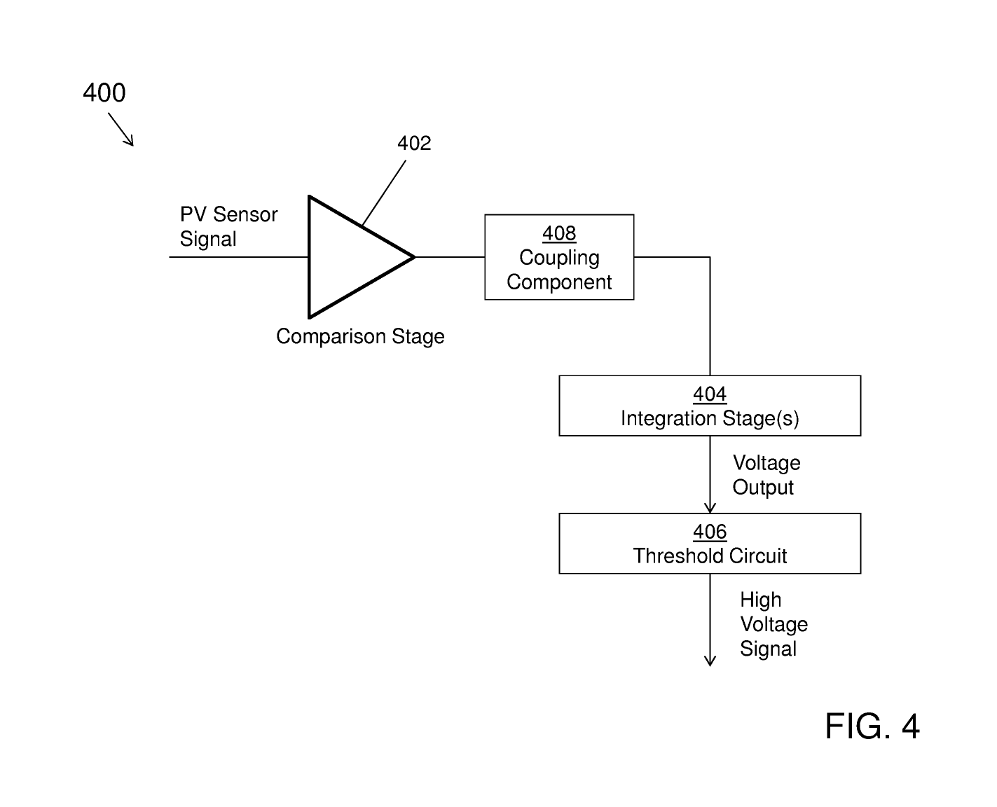

Turning now to FIG. 4, a block diagram of circuit 400 is shown. The circuit 400 may be implemented in connection with one or more components or devices, such as the PV sensor 102a. The circuit 400 may be used to detect whether an intrusion has occurred.

Block 402 may represent a gain stage or comparison stage. The gain stage 402 may receive as input a signal (e.g., a current) from the PV sensor 102a. The signal received from the PV sensor 102a may be sensitive to fluctuations in light, which may be used as a proxy for determining whether an intrusion is occurring.

The gain stage 402 may consume little power. For example, the gain stage may consume less than one microampere of current.

The output of the gain stage 402 may be coupled to an input of one or more analog integration stages 404. The integration stage(s) 404 may be configured to replicate a detection function, potentially using differential equations.

The output of the integration stage(s) 404, which may correspond to a voltage output, may be coupled to an input of a threshold circuit 406. The output of the threshold circuit 406 may be a high voltage signal. The output of the threshold circuit 406 may signify whether an intrusion is detected by the PV sensor 102a. For example, if the fluctuation of (ambient) light detected by the PV sensor 102a is larger than a threshold the high voltage signal may be driven to a first state (e.g., high) and if the fluctuation of (ambient) light is less than the threshold the high voltage signal may be driven to a second state (e.g., low).

The output of the gain stage 402 may be coupled to an input of the integration stage(s) 404 using a coupling component 408. In some embodiments, the coupling component 408 may be a wire, a jumper, a circuit board trace, or the like, such that the output of the gain stage 402 may be directly connected to the input of the integration stage(s) 404. In some embodiments, the coupling component 408 may include a component (e.g., a capacitor) configured to filter short-duration fluctuations in the PV sensor signal (e.g., fluctuations less than a threshold). Such filtration may be used to reduce the likelihood of indicating a false positive due to, e.g., noise or a spurious fluctuation in light detected by the PV sensor 102a.

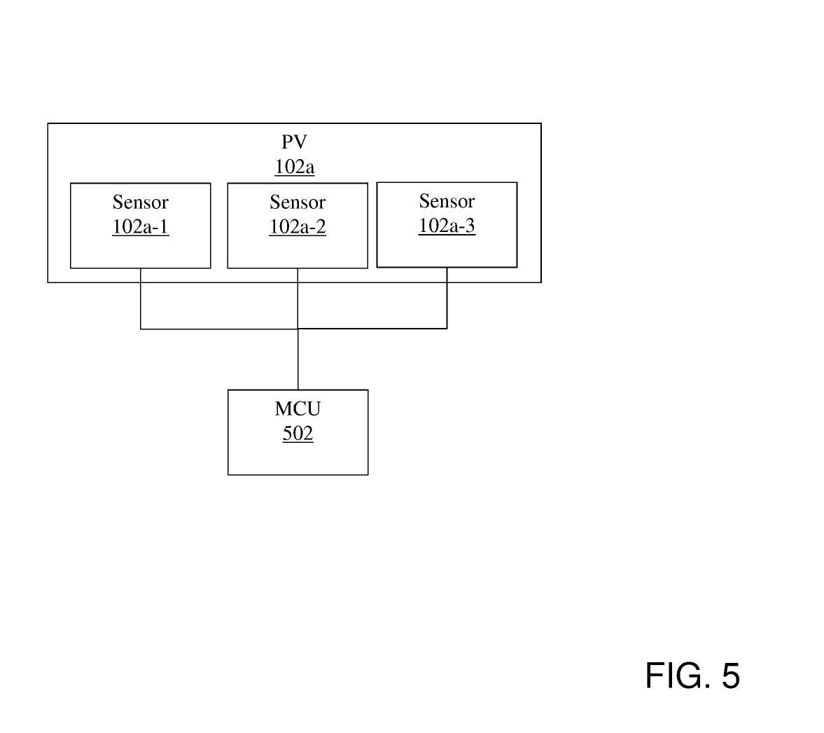

Use of a single PV sensor 102a may be susceptible to light fluctuations caused by small objects that are not intended to be detected as an intrusion. For example, if a bug or fly in the room 104 lands on the surface of the PV sensor 102a, that event could cause a sufficient fluctuation in light to trip the PV sensor 102a. In order to reduce the likelihood of such events triggering a detected intrusion by the PV sensor 102a, a plurality of sensors may be used. For example, FIG. 5 shows the PV sensor 102a comprising three sensors: 102a-1, 102a-2, and 102a-3. Any number of sensors may be included in the PV sensor 102a.

The outputs of the sensors 102a-1 through 102a-3, which may be digitized, may be examined by, e.g., a MCU 502, to determine a status for whether the PV sensor 102a detects an intrusion. For example, if the sensors 102a-1 through 102a-3 vary independently, then a determination may be made that no intrusion is occurring. For example, a “fly” (or other small object) cannot be in two or more places at the same time, and so, the fly is too small to cause light variation in the room to impact all the sensors 102a-1 through 102a-3 in an amount greater than a threshold (e.g., the threshold associated with threshold circuit 406 of FIG. 4). On the other hand, if a majority or all of the sensors 102a-1 through 102a-3 experience a fluctuation in light greater than the threshold, a determination may be made that an intrusion has been detected by the PV sensor 102a. Variation sensitivity may be adjustable to accommodate differing room conditions.

Embodiments of the disclosure may be tied to one or more particular machines. For example, one or more devices, apparatuses, systems, or architectures may be configured to determine or detect when an intrusion is occurring. In some embodiments, a PV sensor, which may include a plurality or array of sensors, may be used to harvest energy for powering a PIR sensor. In some embodiments, the PIR sensor may generally be turned off or disable, but might be turned on or enabled when the PV sensor detects an intrusion is occurring.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method for detecting that an intrusion is occurring, comprising:
detecting, by a first sensor, that the intrusion is occurring based on a variation of light exceeding a threshold;
detecting, by a second sensor, that the intrusion is occurring; and
generating an intrusion status signal that indicates the intrusion is occurring based on determining that the first and second sensors detect that the intrusion is occurring.

2. The method of claim 1, wherein the first sensor comprises a photovoltaic sensor.

3. The method of claim 1, wherein the first sensor comprises a plurality of sensors, and wherein the first sensor detects that the intrusion is occurring when at least a majority of the sensors included in the plurality of sensors detects a variation in the light exceeding the threshold.

4. The method of claim 1, wherein the second sensor is powered by a battery.

5. The method of claim 1, further comprising:
harvesting, by the first sensor, energy; and
powering the second sensor using the harvested energy.

6. The method of claim 1, further comprising:
causing the second sensor to turn on based on the first sensor detecting that the intrusion is occurring.

7. The method of claim 1, further comprising:
wirelessly transmitting the intrusion status signal to a security panel.

8. The method of claim 1, wherein the intrusion status signal is generated using an AND gate.

9. A sensing unit, comprising:
a first sensor configured to detect that an intrusion is occurring based on a variation of light exceeding a threshold;
a second sensor configured to detect that the intrusion is occurring; and
logic configured to generate an intrusion status signal that indicates the intrusion is occurring based on the first and second sensors detecting that the intrusion is occurring.

10. The sensing unit of claim 9, further comprising:
a transmitter configured to wirelessly transmit the intrusion status signal.

11. The sensing unit of claim 9, wherein the first sensor comprises a plurality of sensors, and wherein the first sensor is configured to detect that the intrusion is occurring when at least a majority of the sensors included in the plurality of sensors detects a variation in the light exceeding the threshold.

12. The sensing unit of claim 9, further comprising:
a battery configured to power the second sensor.

13. The sensing unit of claim 9, wherein the first sensor is configured to harvest energy derived from a light source, and wherein the second sensor is configured to be powered using the harvested energy.

14. The sensing unit of claim 9, wherein the second sensor is configured to be turned on based on the first sensor detecting that the intrusion is occurring.

15. The sensing unit of claim 9, further comprising:
a gain stage coupled to an output current signal of the first sensor;
at least one integration stage coupled to an output of the gain stage; and
a threshold circuit coupled to an output of the at least one integration stage,
wherein an output of the threshold circuit is configured as a voltage signal that indicates that the intrusion is occurring.

16. The sensing unit of claim 15, further comprising:
a capacitor coupled to the output of the gain stage and an input of the at least one integration stage.

17. A system comprising:
a sensing unit comprising:
a first sensor configured to detect that an intrusion is occurring based on a variation of light exceeding a threshold;
a second sensor configured to detect that the intrusion is occurring; and
logic configured to generate an intrusion status signal that indicates the intrusion is occurring based on the first and second sensors detecting that the intrusion is occurring; and
a security panel comprising:
a receiver configured to receive the intrusion status signal; and
an interface configured to signal that an intrusion has been detected based on the received intrusion status signal.

18. The system of claim 17, wherein the first sensor comprises a plurality of sensors, and wherein the first sensor is configured to detect that the intrusion is occurring when all of the sensors included in the plurality of sensors detects a variation in the light exceeding the threshold.

19. The system of claim 17, wherein the first sensor is configured to harvest energy derived from a light source, and wherein the second sensor is configured to be powered using the harvested energy.

20. The system of claim 17, wherein the second sensor is configured to be turned on based on the first sensor detecting that the intrusion is occurring.
